(19) United States
(12) Patent Application Publication
(10) Pub. No.: US 2008/0320169 A1
(43) Pub. Date: Dec. 25, 2008

(54) Systems, Methods, and Computer Programs for Enabling a Computing Apparatus to Obtain Data

(76) Inventors: Ian Shaw Burnett, New South Wales (AU); Stephen James Davis, New South Wales (AU)

Correspondence Address: LADAS & PARRY LLP, 224 SOUTH MICHIGAN AVENUE, SUITE 1600, CHICAGO, IL, 60604, US

(21) Appl. No.: 11/813,691

(22) PCT Filed: Jan. 12, 2006
(86) PCT No.: PCT/AU06/00030

§ 371 Date: May 2, 2008

(30) Foreign Application Priority Data
Jan. 12, 2005 (AU) 2005900128
Oct. 7, 2005 (AU) 2005905556

(51) Int. Cl. G06F 15/173

(52) U.S. Cl. 709/247

(57) ABSTRACT

A system for enabling a computing apparatus to obtain data, the system having a processor that is arranged to: process a request issued by the computing apparatus in order to identify a command;

process the request in order to determine a location of a particular node of a tree structure relative to at least one other node in the tree structure if the command corresponds to a first of a plurality of possible commands; and set a response, which is to be sent to the computing apparatus, such that it contains a piece of data that is associated with the particular node to thereby enable the computing apparatus to obtain data.

### FIELD OF THE INVENTION

The present invention relates generally to the field of retrieving data, and has particular—but by no means exclusive application—to enabling a computing apparatus to retrieve one or more pieces of data from an XML file.

### BACKGROUND OF THE INVENTION

Declarative mark-up languages such as the eXensible Mark-up Language (XML) and the Hyper Text Markup Language (HTML) provide many benefits for interoperable communication and data handling. However, declarative mark-up languages also have significant drawbacks. For instance, one of the drawbacks associated with the XML is that an XML file can be many times larger than the raw data described by the XML. Consequently, the XML file may require significantly more storage space to store and may take longer to transfer than the raw data. Furthermore, the XML file may require considerable processing resources due to parsing requirements.

The drawbacks associated with declarative mark-up languages can be particularly problematic for wireless mobile computing devices such as those available from BlackBerry. For instance, downloading the XML file to a wireless mobile computing device may cause more data to be transferred over a wireless data link than the raw data, which may increase the cost of obtaining data. Furthermore, the wireless mobile computing device may have a relatively limited storage capacity and as such storing the XML file on the device may require a significant portion of the device's storage capacity. The mobile wireless computing device may also have a relatively limited processing capacity and as such parsing the XML file may result in processing delays.

### SUMMARY OF THE INVENTION

According to a first aspect of the present invention there is provided a system for enabling a computing apparatus to obtain data, the system comprising a processing means that is arranged to:

process a request issued by the computing apparatus in order to identify a command;

process the request in order to determine a location of a particular node of a tree structure relative to at least one other node in the tree structure if the command corresponds to a first of a plurality of possible commands; and

set a response, which is to be sent to the computing apparatus, such that it contains a piece of data that is associated with the particular node to thereby enable the computing apparatus to obtain data.

A significant advantage of the embodiment of the system is that it effectively enables the computing apparatus to download only selected parts of a file that is based on a declarative mark-up language such as the XML. For example, if the file represented an electronic text book the embodiment of the system would effectively enable the computing apparatus to specify one or more chapters of the book and download only those chapters of the book. This advantage of the embodiment of the system is brought about by virtue of the tree structure, which can be used to represent the file. Each node in the tree structure can represent a piece of data in the file. In this regard, the location information provides the means for enabling the computing apparatus to specify the selected parts (nodes) of the file to be downloaded.

The ability to download only selected parts of the file is particularly attractive for wireless mobile computing devices because it can be used to ensure that only required data is downloaded to the mobile wireless computing device. This ensures that data transmission times and storage requirements (on the wireless mobile computing device) are kept to a minimum. Furthermore, it ensures that only required data is parsed, which keeps processing delays on the wireless mobile computing device to a minimum. Furthermore, downloading only the required data to the mobile wireless computing device ensures only the minimum number of bytes are processed by the mobile wireless device. Thus, the mobile wireless device enjoys the benefit of a longer battery device.

Preferably, the processing means is arranged to decompress compressed data contained in the request in order to identify the command.

Being able to decompress at least one of the commands is advantageous because it facilitates a potential reduction in the amount of actual data that is exchanged between the system and the computing apparatus.

Preferably, the processing means is arranged to set the response such that it identifies a second of the possible commands.

Being able to set the response such that it identifies the second of the possible commands is advantageous because it provides a means for conveying a command (instruction) to the computing apparatus.

Preferably, the processing means is arranged to:

process a file name contained in the request to identify a root node of the tree structure if the command corresponds to a third of the possible commands; and

set the response such that it identifies the root node.

An advantage of sending the root node to the computing device is that the computing apparatus can subsequently use the root node to access and navigate the tree structure.

Preferably, the processing means is arranged to:

process the request to identify at least one child node of the particular node if the command corresponds to the first of the possible commands; and

set the response such that it identifies the child node of the particular node.

Sending the first child node information provides a similar advantage to that of sending the root node; that is, it enables the tree structure to be navigated.

Preferably, the processing means is further arranged to:

check a record to identify a current node in the tree structure if the command corresponds to a fourth of the commands; and

update the record such that it identifies a parent node, or at least one child node, of the current node.

Being able to check and update the record provides the advantage of being able to track a user's current location in the tree structure.

Preferably, the processing means is arranged to set the response such that it identifies the child node of the current node.

Preferably, the processing means is arranged to set the response such that it contains compressed data that can be decompressed to identify any one of the possible commands and/or any one or more nodes of the tree structure.

Preferably, the processing means is arranged to interact with a communication network in order to receive the request from the computing apparatus, and to send the response to the computing apparatus.

Using the communication network provides the advantage of enabling the computing apparatus and system to cooperate in a distributed environment.

Preferably, the tree structure represents a file that conforms to an extensible mark-up language (XML) standard.

Alternatively, the tree structure represents a schema.

Preferably, the possible commands conform to the extensible mark-up language.

According to a second aspect of the present invention there is provided a system for enabling a computing apparatus to obtain data, the system comprising a processing means arranged to:

set a request to be issued by the computing apparatus such that it identifies a command, which corresponds to a first of a plurality of possible commands, and a location of a particular node of a tree structure relative to at least one other node in the tree structure; and

access a piece of data that is contained in a response, which is issued to the computing apparatus, and which is associated with the particular node to thereby enable the computing apparatus to obtain data.

Preferably, the processing means is arranged to process the response in order to identify a second of the possible commands.

Preferably, the processing means is arranged to decompress compressed data in the response in order to identify the second of the possible commands.

Preferably, the processing means is arranged to:

set the request such that it identifies a third of the possible commands and a file name; and

process the response in order to identify a root node that was determined using the file name.

Preferably, the processing means is arranged to:

set the request such that it identifies the particular node; and

process the response to identify at least one child node, which was determined using the particular node identified in the request, of the particular node.

Preferably, the processing means is arranged to set the request such that it identifies a fourth of the possible commands in order to cause a record that identifies a current node of the tree structure to be updated such that it identifies a parent node, or at least one child node, of the current node.

Preferably, the processing means is arranged to process the response in order to identify the child node of the current node.

Preferably, the processing means is arranged to set the request such that it contains compressed data that can be decompressed to identify any one of the possible commands and/or any one or more of the nodes of the tree structure.

Preferably, the processing means is arranged to interact with a communication network in order to receive the request from the computing apparatus, and to send the response to the computing apparatus.

Preferably, the tree structure represents a file that conforms to an extensible mark-up language (XML) standard.

Alternatively, the tree structure represents a schema.

Preferably, the possible commands conform to the extensible mark-up language.

According to a third aspect of the present invention there is provided a method for enabling a computing apparatus to obtain data, the method comprising the steps of:

processing a request issued by the computing apparatus in order to identify a command;

processing the request in order to determine a location of a particular node of a tree structure relative to at least one other node in the tree structure if the command corresponds to a first of a plurality of possible commands; and

setting a response, which is to be sent to the computing apparatus, such that it contains a piece of data that is associated with the particular node to thereby enable the computing apparatus to obtain data.

Preferably, the step of processing the request to identify the command comprises decompressing compressed data contained in the request in order to identify the command.

Preferably, the step of setting the response comprises setting the response such that it identifies a second of the possible commands.

Preferably, the method comprises the step of:

processing a file name contained in the request to identify a root node of the tree structure if the command corresponds to a third of the possible commands; and

setting the response such that it identifies the root node.

Preferably, the method comprises the steps of:

processing the request to identify at least one child node of the particular node if the command corresponds to the first of the possible commands; and

setting the response such that it identifies the child node of the particular node.

Preferably, the method comprises the steps of:

checking a record to identify a current node in the tree structure if the command corresponds to a fourth of the commands; and

updating the record such that it identifies a parent node, or at least one child node, of the current node.

Preferably, the method comprises the step of setting the response such that it identifies the child node of the current node.

Preferably, the method comprises the step of setting the response such that it contains compressed data that can be decompressed to identify any one of the possible commands and/or any one or more nodes of the tree structure.

Preferably, the method comprises the step of interacting with a communication network in order to receive the request from the computing apparatus and/or send the response to the computing apparatus.

Preferably, the tree structure represents a file that conforms to an extensible mark-up language (XML) standard.

Alternatively, the tree structure represents a schema.

Preferably, the possible commands conform to the extensible mark-up language.

According to a fourth aspect of the present invention there is provided a method for enabling a computing apparatus to obtain data, the method comprising the steps of:

setting a request to be issued by the computing apparatus such that it identifies a command, which corresponds to a first of a plurality of possible commands, and a location of a particular node of a tree structure relative to at least one other node in the tree structure; and

accessing a piece of data that is contained in a response, which is issued to the computing apparatus, and which is associated with the particular node to thereby enable the computing apparatus to obtain data.

Preferably, the method comprises the step of processing the response in order to identify a second of the possible commands.

Preferably, the method comprises the step of decompressing compressed data in the response in order to identify the second of the possible commands.

Preferably, the method comprises the steps of:

setting the request such that it identifies a third of the possible commands and a file name; and

processing the response in order to identify a root node that was determined using the file name.

Preferably, the method comprises the steps of:

setting the request such that it identifies the particular node; and

processing the response to identify at least one child node, which was determined using the particular node identified in the request, of the particular node.

Preferably, the method comprises the step of setting the request such that it identifies a fourth of the possible commands in order to cause a record that identifies a current node of the tree structure to be updated such that it identifies a parent node, or at least one child node, of the current node.

Preferably, the method comprises the step of processing the response in order to identify the child node of the current node.

Preferably, the method comprises the step of setting the request such that it contains compressed data that can be decompressed to identify any one of the possible commands and/or any one or more of the nodes of the tree structure.

Preferably, the method comprises the step of interacting with a communication network in order to receive the request from the computing apparatus and/or to send the response to the computing apparatus.

Preferably, the tree structure represents a file that conforms to an extensible mark-up language (XML) standard.

Alternatively, the tree structure represents a schema.

Preferably, the possible commands conform to the extensible mark-up language.

According to a fifth aspect of the present invention there is provided a computer program comprising at least one instruction for causing a computing system to carry out the method described in the third aspect of the present invention.

According to a sixth aspect of the present invention there is provided a computer readable medium comprising the computer program according to the fifth aspect of the present invention.

According to a seventh aspect of the present invention there is provided a computer program comprising at least one instruction for causing a computer apparatus to carry out the method described in the fourth aspect of the present invention.

According to an eighth aspect of the present invention there is provided a computer readable medium comprising the computer program according to the seventh aspect of the present invention.

### BRIEF DESCRIPTION OF THE DRAWINGS

Notwithstanding any other embodiments that may fall within the scope of the present invention, a particular embodiment of the present invention will now be described, by way of example only, with reference to the accompanying figures, in which:

FIG. 1 is a schematic diagram of a system in accordance with the particular embodiment of the present invention;

FIG. 2 contains a table of commands used in the system illustrated in FIG. 1;

FIG. 3 is a screen shot of a graphical user interface of a client application used in the system illustrated in FIG. 1;

FIG. 4 provides an illustration of a particular interaction between entities in the system shown in FIG. 1;

FIG. 5 is a flow chart of various steps performed by an entity in the system shown in FIG. 1;

FIG. 6 is a flow chart of various steps performed by another entity in the system shown in FIG. 1; and

FIG. 7 is an example XML schema used in the system of FIG. 1.

### AN EMBODIMENT OF THE INVENTION

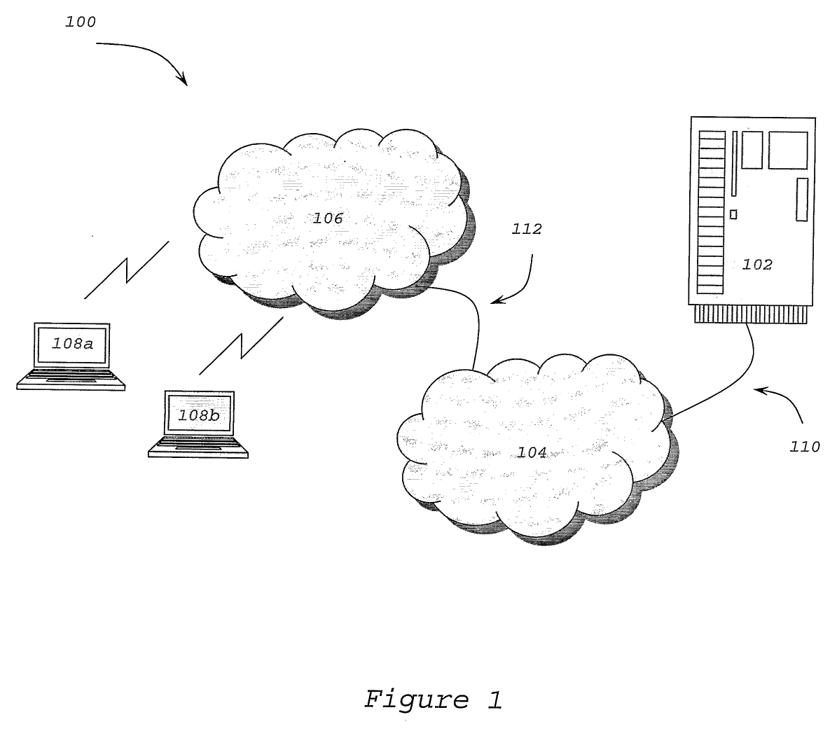

With reference to FIG. 1, which illustrates a system 100 in accordance with an embodiment of the present invention, the system 100 comprises a computer system 102 in the form of a web server, a communication network 104 in the form of a public access packet switched network (such as the Internet), a wireless communication network 106 in the form of a mobile telephone network, and a number of wireless mobile computing devices 108 in the form of BlackBerry devices.

The computer system 102 is connected to the communication network 104 via a high speed data communication link 110 in the form of an xDSL link. As persons skilled in the art will readily appreciate the communication link 110 may be in other forms (such as an ISDN link or fibre optic link) in alternative embodiments of the present invention.

The computer system 102 comprises traditional computer hardware including: a motherboard; random access memory; a power supply; a network interface that is coupled to the data communication link 110; and a hard disk that is loaded with an operating system in the form of Microsoft Windows Server 2003. Persons skilled in the art will readily appreciate that other forms of the operating system (such as Linux or UNIX) can be used in alternative embodiments of the present invention. The hard disk is also loaded with a number of files that conform to a declarative mark-up language in the form of the XML. The number of files could include, for example, an MPEG-21 digital item declaration. It is envisaged that in an alternative embodiment of the present invention the number of files may conform to different declarative mark-up languages including the Standard Generalised Mark-up Language (SGML) or the Hyper Text Mark-up Language (HTML). It is also envisaged that in an alternative embodiment of the present invention the number of files conform to a schema language such as, for example, XML Schema. The hard disk of the computer system 102 is also loaded with a software utility that enables the wireless mobile computing devices 108 to download pieces of data from the number of files loaded on the hard disk of the computer system 102.

As mentioned previously, the communication network 104 is in the form of a packet switched network and as such comprises a plurality of interconnected routers (not shown in the figures) that support the Internet Protocol (IP) standards. The communication network 104 is connected to the wireless network 106 via a high speed data communication link 112 in the form of a fibre optic cable. Persons skilled in the art will, however, appreciate that the link 112 may be in a different form (such as an ISDN link) in an alternative embodiment of the present invention.

As previously described, the wireless communication network 106 is in the form of a mobile telephone network. Consequently, persons skilled in the art will readily appreciate that the network 106 essentially comprises a number of base stations (not shown in the figures) that are arranged to transmit and receive radio signals to and from the wireless mobile computing devices 108. Persons skilled in the art will also readily appreciate that the wireless communication network 106 comprises a central computer system (also not shown in the figures) that controls the operation of the base stations.

Each of the wireless mobile computing devices 108 comprises traditional computing hardware including a processing board, random access memory, a visual display component in the form of a colour LCD screen, a power supply and a permanent storage device that is loaded with an operating system in the form of BlackBerry OS. The permanent storage device is also loaded with a software utility that enables the respective wireless mobile computing device 108 to download pieces of data from the number of files loaded on the hard disk of the computer system 102, which accord with the XML or alternatively conform to a schema language.

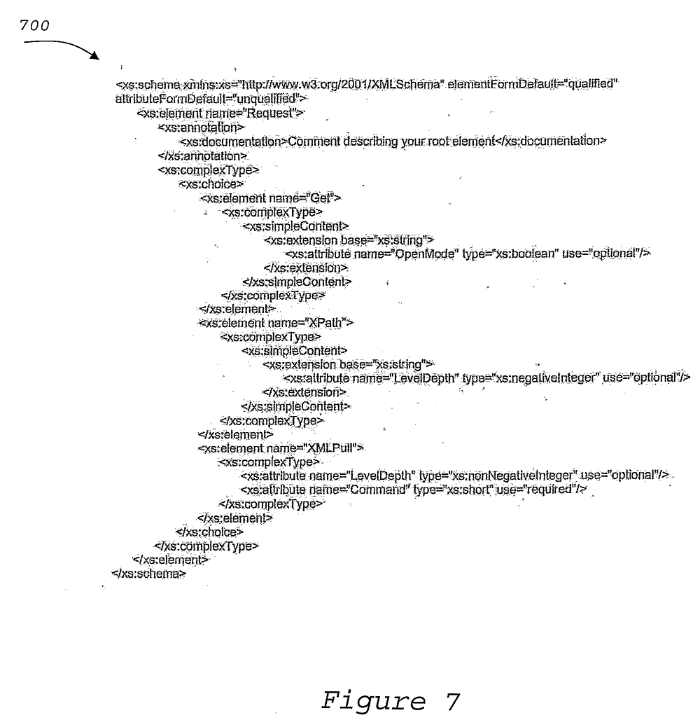

In regard to the software utility loaded on the permanent storage device of a wireless mobile computing device 108, the software utility is operable to issue one or more requests to the computer system 102. The requests issued by a wireless mobile computing device 108 are transferred from the wireless mobile computer device 108 to the computer system 102 in one or more data packets that traverse the wireless communication network 106 and the communication network 104. The requests sent by the wireless mobile computing devices 108 conform to an XML schema 700. An example of this schema 700 is shown in FIG. 7.

The requests sent by the software utility of a wireless mobile computing device 108 are of the following form:

| | | |
|---|---|---|
| Command | Action | Mode |

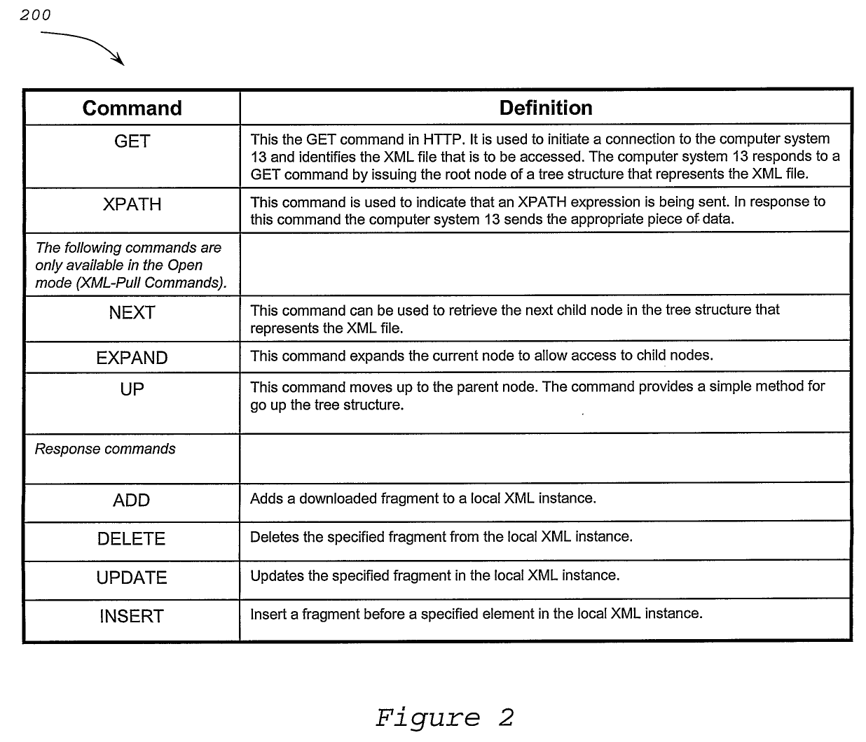

The “Command” field of a request defines what method the computer system 102 is to perform on receiving a request. The various commands that can be included in the “Command” field are listed in the table 200, which is shown in FIG. 2. A brief description of the commands is also included in the table 200 shown in FIG. 2. In the present embodiment of the invention the commands GET, XPATH, NEXT, EXPAND, BACK and UP are sent from the wireless mobile computing devices 108 to the computer system 102. The commands ADD, DELETE, UPDATE and INSERT (XML Pull commands) are, however, sent from the computer system 102 to the wireless mobile computing devices 108. It is noted that the present invention may have application in a peer-to-peer collaborative editing and as such all the commands could be available for use by the computer system 102 and the wireless mobile computing devices 108.

The “Action” field of a request takes the form /path/to/file.xml for a GET command, or a valid XPath expression for an XPATH command. The “Mode” field is used to define whether the computer system 102 should keep a data connection to the wireless mobile computing device 108 open or close the data connection subsequent to receiving a GET command.

In regard to keeping the data connection open or closing the data connection, it is noted that using the “Mode” field to specify that the connection should be maintained in an open state indicates to the computer system 102 that a wireless mobile computing device 108 wishes to keep the data connection open to submit further requests in that particular session. When the computer system 102 maintains the data connection in a open state it will keep track of its position locally in one or more tree structures (or Document Object Model, DOM) representing the number of files (which accord with the XML) loaded on the computer system 102. In the ‘open’ mode all commands listed in the table 200 of FIG. 2 can be issued by the wireless mobile computing device 108. Furthermore, the computer system 102 can accept XPath expressions with the form ./ to indicate the current location (node) in the tree structure.

Using the “Mode” field to specify that the data connection should be closed indicates to the computer system 102 that it need not keep track of its position locally in the tree structures. In the ‘closed’ mode requests submitted to the computer system 102 are via a full XPath expression.

When the computer system 102 receives a request from a wireless mobile computing device 108, the computer system 102 basically processes the request and sends to the appropriate wireless mobile computing device 108 the relevant piece(s) of data from the number of files loaded onto the hard disk of the computer system 102.

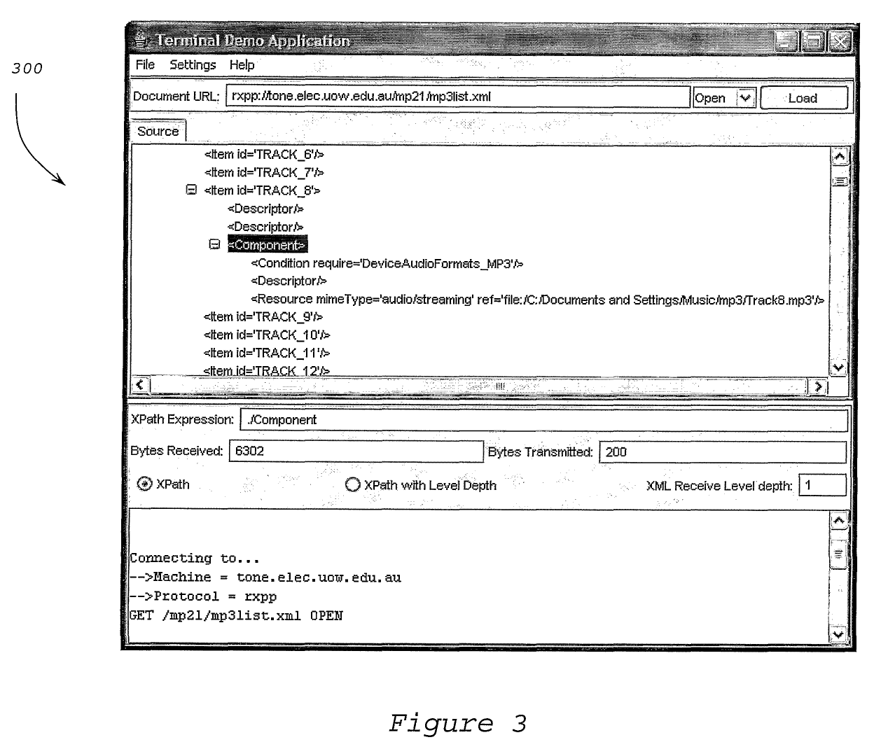

To better illustrate the process involved in downloading data from the computer system 102 to a wireless mobile computing device 108, the following describes an example interaction between a client application (which has been written in JAVA) running on a wireless mobile computing device 108 and the computer system 102. A screen shot 300 of the Graphical User Interface (GUI) of the client application is shown in FIG. 3. It is noted that the client application incorporates the software utility loaded on a wireless mobile computing device 108.

The client application basically enables a user to navigate through an XML file, or alternatively a schema, loaded on the computer system 102, and retrieve those nodes (of the tree structure that represents the XML file or schema) that have been selected by a mouse click. The XML file that is shown in the screen shot 300 of the client application represents a typical MPEG-21 Digital Item Declaration (DID), which is capable of incorporating a significant amount of metadata. More specifically, the DID shown in the screen shot 300 of the client application is a user's MP3 play-list, which describes all the MP3 tracks, including MPEG-7 descriptors of each track, possible bit rate variations, and the location of the MP3 file.

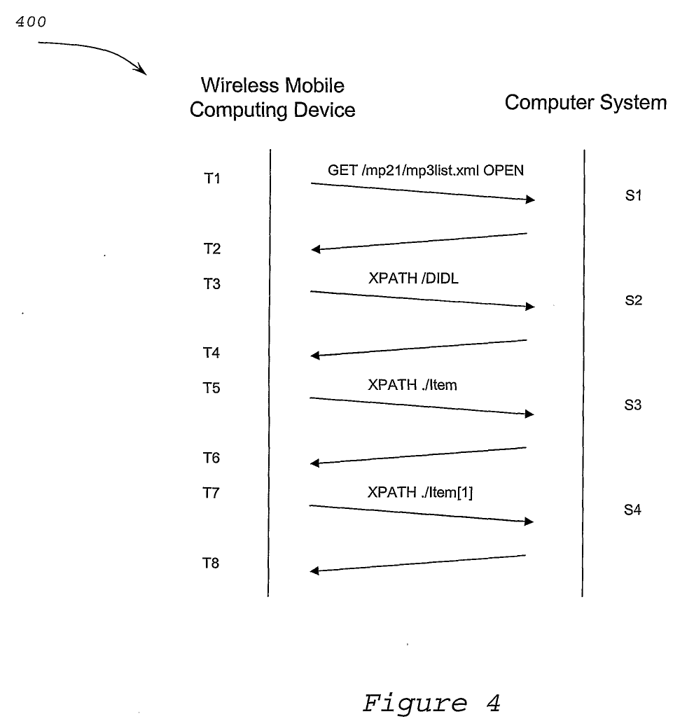

With reference to FIG. 4, which provides a sequence diagram 400 of a particular interaction between a wireless mobile computing device 108 and the computer system 102, at time T1 (at a wireless mobile computing device 108) the user requests the XML file, and at S1 the computer system 102 processes the GET command. The computer system 102 opens the XML file and sends the XML root node (<DIDL>) to the wireless mobile computing device 108. The client application receives this XML at T2. The user then requests the child nodes of DIDL at T3 and selects the new child node (<Item>) at T5. The user now has enough information to see the list of music tracks, as defined in the XML file, and chooses the Item, at T7, which contains the information about the first track as well as a link to the associated MP3 file.

Assuming the user is playing these tracks on a wireless mobile computing device 108. The user configures the device 108 to play random songs for one hour. Using this process the client application is configured to retrieve the next random track descriptor after the previous track has finished. The average download and upload per track in this example is 450 bytes and 55 bytes respectively. In this scenario, over the period of one hour, the wireless mobile computing device 108 has uploaded a total of 1,100 bytes and only downloaded 11,737 bytes. If this was all the user intended on doing, and considering the original document size of 613,777 bytes, this is a significant saving.

To further improve the efficiency of the exchange of data between the computer system 102 and any one of the wireless mobile computing devices 108, the software utilities loaded on the computer system 102 and each of the wireless mobile computing devices 108 is capable of performing data compression on data that is to be transferred between each other. Essentially, the compression technique employed by the software utilities compresses the various commands (as set out in the table 200 of FIG. 2) and optionally pieces of data (fragments of an XML file) that the wireless mobile computing devices 108 download from the computer system 102. More specifically, the compression technique employed is a schema/tree based compression that relies on the fact that the metadata structure is known by both the computer system 102 and the wireless mobile computing devices 108. Consequently, schema elements are assigned a unique binary code, thereby eliminating the need to send tags in a textual (human readable) form.

To better illustrate the compression technique, consider the example schema below:

Media

[CHOICE] {1,Unbounded}

Music (0) {0,1}

[CHOICE] {0, Unbounded}

Song (0) {0,1}
[SEQUENCE] {1,1}

| | |
|---|---|
| Title | {1,1} |
| Description | {0,1} |
| Artist | {1,1} |
| Format | {1,0} |
| Rating | {0,1} |
| Length | {0,1} |

...

Videos (1)

...

The generated binary codes are surrounded by round brackets; that is, (010) defines the second child. The minimum occurrence and maximum occurrence of all nodes of the tree structure are surrounded by curly braces respectively; that is {0, Unbounded} indicates that the node does not need to occur, and there is no upper bound on the number of times it may appear. To illustrate the bit savings, consider the Media element from the schema above. The Media element has a choice of two children, which are Music and Videos. Since there are only two options, this can be represented with just one bit. Thus, the Music node, which is 40 bits as a string, can be represented by its binary code of just 1 bit, ‘0’.

Consider further the transfer of an XPath expression (locator) from a wireless mobile computing device 108 to the computer system 102. As indicated previously, an XPath locator is defined as the XPath expression which specifies the path and position of an element (node) in the tree structure that represents the XML file. The navigation aspect of the embodiments of the present invention ensures that for each element selected by the XPath locator, all direct child nodes are returned. Initially, after a GET command, the XML file root node, Media, is selected by the computer system 102. The namespace URIs are transmitted to the wireless mobile computing device 108; in order, along with the root node binary code. This provides the wireless mobile computing device 108 with enough information to load all necessary schemas and create binary codes for the decompression process. The model group [CHOICE] and only its direct child nodes are then encoded. First, using VLC5, which is a method for encoding numbers of an unknown size, the number of choices are encoded. The XML element Music is present in this XML instance, thus a 0 is written which is the choice code to select Music. Since this node does not allow attributes we continue to the next sibling. The second choice is Videos, and a 1 is written. The total bits sent to the client in this request would be just seven bits; that is, 0000101. This process would continue for the next requested node.

Since the XML is valid to a schema, it is known that the XPath Locators must follow the schema rules to be valid. By exploiting this information it is possible to apply the same compression technique as used for the XML. This process is slightly different, however, as the compressed XPath Locators do not contain the XML model group information and the action is always a choice (identifying exactly one node). The compression of an XPath locator has three steps: (1) get the binary code for current element; (2) if the parent allows multiple children, then a mandatory Integer needs to be encoded to indicate the position of the child element; (3) an integer indicating the child element counter (for multiply occurring child nodes).

For example, for the XML fragment below an XPath locator is “/Media/Music/Song[2]”.

<RXEP xmlns=“RXEP:2004”>

<Add location=“/Media/Music/Song[2]”

ns=“medians:2004”>

<Title>Hit.2</Title>
<Description>Song 2</Description>
<Artist>B. Artist</Artist>
<Format>OGG</Format>
<Length>03:46</Length>

</Add>

</RXEP>

Since Media is the only root node, it is mandatory and thus no bits are required. The binary code for Music is 0 and since there can be an unbounded number of Music (via the choice), a position code of one is encoded using VLC5; that is, 00001. Following the same process for Song[2] a 0 is used to select the Song node and 00010 for the second position code. Since there may be a number of Songs the ‘counter’ is needed to represent the [2], which would be 00010 as VLC5. The total output is 00000100001000010 (17 bits) which is significantly less than the string representation of 160 bits.

Consider using XML-Pull commands (identified in the table 200 of FIG. 2) rather than XPath Locators. Instead of receiving all the direct child nodes from a selected node the XML is stepped through on a per-node basis. This analogous to XML Remote Pull-parsing in which the ‘parsing’ is truly remote (i.e. across a network).

The XML document is requested and the code representing the root element is returned: that is Media. A mobile wireless computing device 108 sends the binary code representing the Expand command, which instructs the computer system 102 to expand the Media node and return the binary code for the first child node, in this case ‘0’, the code for Music. Using the application (loaded on a wireless mobile computing device 108) a user selects music which sends the binary code expand, the received binary code ‘0’ indicates that a Song element is present and the following bits represent the attribute ‘Hit1’. The user does not want this song and the binary code for next is sent which moves the position to the next sibling on the system 102. The system 102 sends the binary bit ‘0’ to indicate another Song element is present and the following bits indicate the attribute ‘Hit2’. The user determines this is the desired song, and sends the binary code for Expand, in this case the first element Title is mandatory and no code is needed to represent the element. The bits received indicate the value for the Title of the requested song.

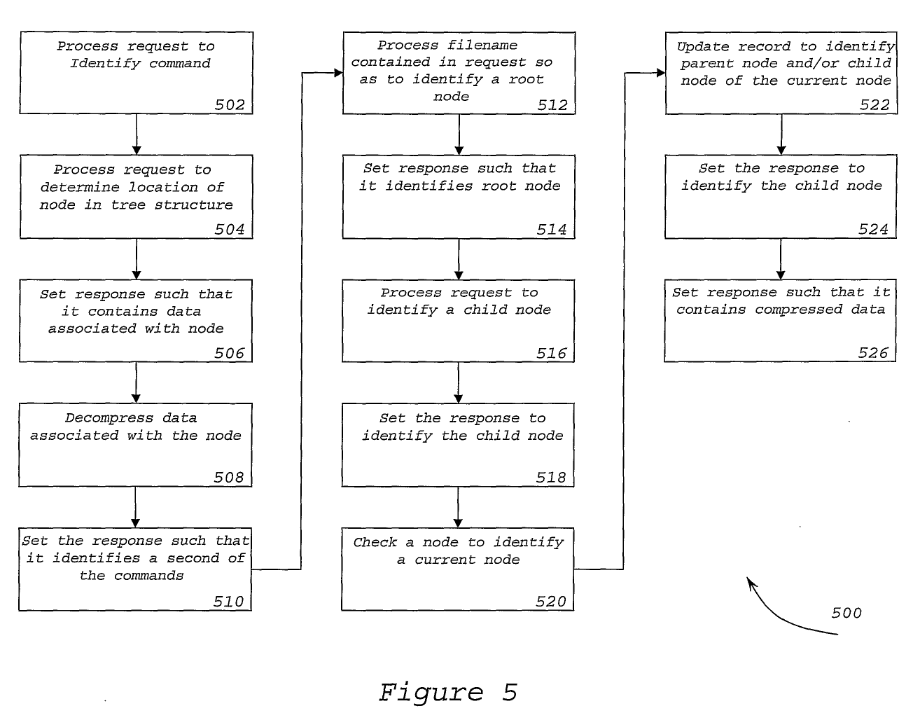

By way of summary, FIG. 5 provides a flow chart of the various steps performed by the software utility loaded on the computer system 102 (which enables the devices 108 to download pieces of data). The first step 502 performed by the software utility is to process a request issued by the computing apparatus in order to identify a command. Following on from the initial step 502, the software utility performs the step 504 of processing the request to determine a location of a node in a tree structure relative to another node in the tree structure if the command corresponds to one of a plurality of commands. Once the software utility has performed the second step 504 it proceeds to carry out the step 506 of setting a response, which is to be sent to the computing apparatus, such that it contains data that is associated with the node.

In addition to the previous steps 502 to 506, the software utility is also arranged to perform the step 508 of decompressing compressed data that is associated with the particular node of the tree structure. The software utility also performs the step 510 of setting the response such that it identifies a second of the possible commands. Furthermore, the software utility also performs the step 512 of processing a filename contained in the request to identify a root node of the tree structure if the command corresponds to a third of the commands. The software utility also carries out the step 514 of setting the response such that it identifies the root node.

The software utility is also arranged to perform the step 516 of processing the request to identify a child node if the command corresponds to a first of the commands. After the previous step 516 the software utility performs the step 518 of setting the response such that it identifies the child node. At this point the software utility can perform the step 520 of checking a record to identify a current node in the tree structure if the command corresponds to a fourth command. Following on from the last step 520 the software utility performs the step 522 of updating the record such that it identifies a parent node, or at least one child node, of the current node.

In addition to the earlier steps 502 to 522, the software utility performs the step 524 of setting the response such that it identifies the child node. At this point the software utility can also perform the step 526 of setting the response such that it contains compressed data that can be decompressed to identify a command and nodes in the tree structure.

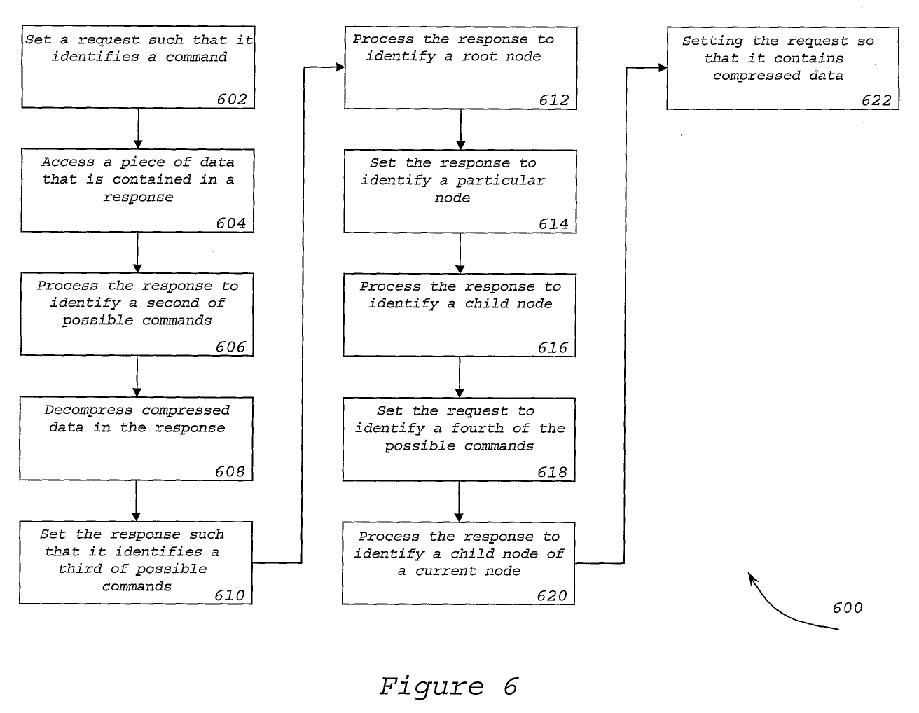

In summary, the flow chart 600 of FIG. 6 illustrates the steps performed by the software utility loaded on each wireless mobile computing device 108. In this regard, the first step 602 that is performed involves setting a request to be issued by the computing apparatus such that it identifies a command, which corresponds to a first of a plurality of possible commands, and a location of a particular node in a tree structure relative to at least one other node in the tree structure. The second step 604 performed by the software utility is to access a piece of data that is contained in a response, which is issued to the computing apparatus, and which is associated with the particular node. The software utility is also capable of performing the step 606 of processing the response to identify a second of the possible commands.

In addition to the previous steps 602 to 606, the software utility also performs the step 608 of decompressing compressed data in the response in order to identify the second of the commands. The software utility is also capable of carrying out the step 610 of setting the request such that it identifies a third of the possible commands and a filename. Following on from the last step 610 the software utility performs the step 612 of processing the response to identify a root node that was determined using the filename. The software utility is also arranged to perform the step 614 of setting the request such that it identifies the particular node, and the step 616 of processing the response to identify a child node, which was determined using the particular node identified in the request, of the particular node.

In addition to the previous steps 602 to 616, the software utility performs the step 618 of setting the request such that it identifies a fourth of the possible commands to cause a record that identifies a current node of the tree structure to be updated such that it identifies a parent node, or at least one child node, of the current node. The software utility is also arranged to perform the step 620 of processing the response to identify the child node of the current node. As a final step the software utility carries out the step 622 of setting the request so that it contains compressed data that can be decompressed to identify any one of the possible commands and/or any one or more of the nodes of the tree structure.

Those skilled in the art will appreciate that the invention described herein is susceptible to variations and modifications other than those specifically described. It should be understood that the invention includes all such variations and modifications which fall within the spirit and scope of the invention.

1. A system for enabling a computing apparatus to obtain data, the system comprising a processing means that is arranged to:
process a request issued by the computing apparatus in order to identify a command;
process the request in order to determine a location of a particular node of a tree structure relative to at least one other node in the tree structure if the command corresponds to a first of a plurality of possible commands; and
set a response, which is to be sent to the computing apparatus, such that it contains a piece of data that is associated with the particular node to thereby enable the computing apparatus to obtain data.

2. The system as claimed in claim 1, wherein the processing means is arranged to decompress compressed data contained in the request in order to identify the command.

3. The system as claimed in claim 1, wherein the processing means is arranged to set the response such that it identifies a second of the possible commands.

4. The system as claimed in claim 1, wherein the processing means is arranged to:
process a file name contained in the request to identify a root node of the tree structure if the command corresponds to a third of the possible commands; and
set the response such that it identifies the root node.

5. The system as claimed in claim 1, wherein the processing means is arranged to:
process the request to identify at least one child node of the particular node if the command corresponds to the first of the possible commands; and
set the response such that it identifies the child node of the particular node.

6. The system as claimed in claim 1, wherein the processing means is further arranged to:
check a record to identify a current node in the tree structure if the command corresponds to a fourth of the commands; and
update the record such that it identifies a parent node, or at least one child node, of the current node.

7. The system as claimed in claim 6, wherein the processing means is arranged to set the response such that it identifies the child node of the current node.

8. The system as claimed in claim 1, wherein the processing means is arranged to set the response such that it contains compressed data that can be decompressed to identify any one of the possible commands and/or any one or more nodes of the tree structure.

9. The system as claimed in claim 1, wherein the processing means is arranged to interact with a communication network in order to receive the request from the computing apparatus, and to send the response to the computer apparatus.

10. The system as claimed in claim 1, wherein the tree structure represents a file that conforms to an extensible mark-up language standard.

11. The system as claimed in claim 1, wherein the tree structure represents a schema.

12. The system as claimed in claim 1, wherein the possible commands conform to the extensible mark-up language.

13. A system for enabling a computing apparatus to obtain data, the system comprising a processing means arranged to:
set a request to be issued by the computing apparatus such that it identifies a command, which corresponds to a first of a plurality of possible commands, and a location of a particular node of a tree structure relative to at least one other node in the tree structure; and
access a piece of data that is contained in a response, which is issued to the computing apparatus, and which is associated with the particular node to thereby enable the computing apparatus to obtain data.

14. The system as claimed in claim 13, wherein the processing means is arranged to process the response in order to identify a second of the possible commands.

15. The system as claimed in claim 13, wherein the processing means is arranged to decompress compressed data in the response in order to identify the second of the possible commands.

16. The system as claimed in claim 13, wherein the processing means is arranged to:
set the request such that it identifies a third of the possible commands and a filename; and
process the response in order to identify a root node that was determined using the file name.

17. The system as claimed in claim 13, wherein the processing means is arranged to:
set the request such that it identifies the particular node; and
process the response to identify at least one child node, which was determined using the particular node identified in the request, of the particular node.

18. The system as claimed in claim 13, wherein the processing means is arranged to set the request such that it identifies a fourth of the possible commands in order to cause a record that identifies a current node of the tree structure to be updated such that ft identifies a parent node, or at least one child node, of the current node.

19. The system as claimed in claim 18, wherein the processing means is arranged to process the response in order to identify the child node of the current node.

20. The system as claimed in claim 13, wherein the processing means is arranged to set the request such that it contains compressed data that can be decompressed to identify any one of the possible commands and/or any one or more of the nodes of the tree structure.

21. The system as claimed in claim 13, wherein the processing means is arranged to interact with a communication network in order to receive the request form the computing apparatus, and to send the response to the computing apparatus.

22. The system as claimed in claim 13, wherein the tree structure represents a file that conforms to an extensible mark-up language (XML) standard.

23. The system as claimed in claim 13, wherein the tree structure represents a schema.

24. The system as claimed in claim 13, wherein the possible commands conform to the extensible mark-up language.

25. A method for enabling a computing apparatus to obtain data, the method comprising the steps of:
processing a request issued by the computing apparatus in order to identify a command;
processing the request in order to determine a location of a particular node of a tree structure relative to at least one other node in the tree structure if the command corresponds to a first of a plurality of possible commands; and
setting a response, which is to be sent to the computing apparatus, such that it contains a piece of data that is associated with the particular node to thereby enable the computing apparatus to obtain data.

26. The method as claimed in claim 25, wherein the step of processing the request to identify the command processing comprises decompressing compressed data contained in the request in order to identify the command.

27. The method as claimed in claim 25, wherein the step of setting the response comprises setting the response such that it identifies a second of the possible commands.

28. The method as claimed in claim 25, comprising the steps of:
processing a file name contained in the request to identify a root node of the tree structure if the command corresponds to a third of the possible commands; and
setting the response such that it identifies the root node.

29. The method as claimed in claim 25, comprising the steps of:
processing the request to identify at least one child node of the particular node if the command corresponds to the first of the possible commands; and
setting the response such that it identifies the child node of the particular node.

30. The method as claimed in claim 25, comprising the steps of:
checking a record to identify a current node in the tree structure if the command corresponds to a fourth of the commands; and
updating the record such that it identifies a parent node, or at least one child node, of the current node.

31. The method as claimed in claim 30, comprising the step of setting the response such that it identifies the child node of the current node

32. The method as claimed in claim 25, comprising the step of setting the response such that it contains compressed data that can be decompressed to identify any one of the possible and/or any one or more nodes of the tree structure.

33. The method as claimed in claim 25, comprising the step of interacting with a communication network in order to receive the request from the computing apparatus and/or send the response to the computing apparatus.

34. The method as claimed in claim 25, wherein the tree structure represents a file that conforms to an extensible mark-up language (XML) standard.

35. The method as claimed in claim 25, wherein the tree structure represents a schema.

36. The method as claimed in claim 25, wherein the possible commands conform to the extensible mark-up language.

37. A method for enabling a computing apparatus to obtain data, the method comprising the steps of:
setting a request to be issued by the computing apparatus such that it identifies a command, which corresponds to a first of a plurality of possible commands, and a location of a particular node of a tree structure relative to at least one other node in the tree structure; and
accessing a piece of data that is contained in a response, which is issued to the computing apparatus, and which is associated with the particular node to thereby enable the computing apparatus to obtain data.

38. The method as claimed in claim 37, comprising the step of processing the response in order to identify a second of the possible commands.

39. The method as claimed in claim 37, comprising the step of decompressing compressed data in the response in order to identify the second of the possible commands.

40. The method as claimed in claim 37, comprising the steps of:
setting the request such that it identifies a third of the possible commands and a file name; and
processing the response in order to identify a root node that was determined using the file name.

41. The method as claimed in claim 37, comprising the steps of:
setting the request such that it identifies the particular node; and
processing the response to identify at least one child node, which was determined using the particular node identified in the request, of the particular node.

42. The method as claimed in claim 37, comprising the step of setting the request such that it identifies a fourth of the possible commands in order to cause a record that identifies a current node of the tree structure to be updated such that it identifies a parent node, or at least one child node, of the current node.

43. The method as claimed in claim 42, comprising the step of processing the response in order to identify the child node of the current node.

44. The method as claimed in claim 37, comprising the step of setting the request such that it contains compressed data that can be decompressed to identify any one of the possible commands and/or any one or more of the nodes of the tree structure.

45. The method as claimed in claim 37, comprising the step of interacting with a communication network in order to receive the request from the computing apparatus and/or to send the response to the computing apparatus.

46. The method as claimed in claim 37, wherein the tree structure represents a file that conforms to an extensible mark-up language (XML) standard.

47. The method as claimed in claim 37, wherein the tree structure represents a schema.

48. The method as claimed in claim 37, wherein the possible commands conform to the extensible mark-up language.

49. A computer program comprising at least one instruction for causing a computing system to carry out the method as claimed in claim 25.

50. A computer program comprising at least one instruction for causing a computer apparatus to carry out the method as claimed in claim 37.

51. A computer readable medium comprising the computer program defined in claim 49.
